(19) United States
(12) Patent Application Publication
(10) Pub. No.: US 2023/0405799 A1
(43) Pub. Date: Dec. 21, 2023

(54) DRIVERLESS TRANSPORT VEHICLE

(71) Applicant: Saurer Technologies GmbH & Co. KG, Krefeld (DE)

(72) Inventors: Markus SCHAUENBURG, Rechberghausen (DE); Albert STITZ, Kuerten (DE)

(21) Appl. No.: 18/331,286

(22) Filed: Jun. 8, 2023

(30) Foreign Application Priority Data
Jun. 21, 2022 (LU) LU502324

(51) Int. Cl. B25J 5/00; B25J 15/06; B25J 19/02

(52) U.S. Cl. CPC B25J 5/007; B25J 15/0616; B25J 19/022; B25J 19/023

(57) ABSTRACT

A driverless transport vehicle for autonomous transport and replacement of at least one spinning can. In order to provide a driverless transport vehicle which reliably ensures an automated supply of the spinning machines fed with fibre band, the driverless transport vehicle has an autonomous travelling drive, a transport platform for accommodating the at least one spinning can, and a manipulator unit for taking up and setting down the at least one spinning can, the manipulator unit having a gripper for grasping the spinning can and an actuating device for adjusting the gripper.

### CROSS-REFERENCE TO RELATED APPLICATION

This claims priority from Luxembourg Application No. LU502324, filed Jun. 21, 2022, the disclosure of which is hereby incorporated by reference in its entirety.

### FIELD OF THE INVENTION

The present invention relates to a driverless transport vehicle for autonomous transport and replacement of at least one spinning can.

### BACKGROUND OF THE INVENTION

It is already known from the current state of technology that a trolley is to be provided for the transport of at least one spinning can between a fibre band-delivering spinning machine and a fibre band-fed spinning machine. Usually, the trolley is moved between the spinning machines and loaded and unloaded by an operator who places the spinning cans filled with fibre band on the trolley at the spinning machine delivering the fibre band and removes them from the spinning machine fed with fibre band and places them in a suitable position. A continuous supply of fibre band in the fibre band-fed spinning machine is thus dependent on the individual personnel, which can subsequently lead to an unreliable supply of the fibre band-fed spinning machine and possibly to a production standstill.

Proceeding therefrom, the invention addresses the problem of providing a driverless trolley which ensures reliable automated supply to the fibre band-fed spinning machine.

### SUMMARY OF THE INVENTION

According to an embodiment of the present invention, the driverless transport vehicle for autonomous transport and the replacement of at least one spinning can is comprised of
An autonomous travelling drive,
A transport platform for receiving the at least one spinning can, and
An autonomous manipulator unit for taking up and setting down the at least one spinning can, whereby the manipulator unit features a gripper for gripping the spinning can and an actuating device for the variable-position adjustment of the gripper.

The travelling drive according to an embodiment of the present invention is embodied to travel autonomously to a defined position and, in particular, to have the further advantage of determining its destination automatically, i.e. which take-off spindle is to be approached. Driverless transport vehicles are widely known. These are controlled in a collective, either centrally or individually, to travel to defined positions or locations. In a collective control system, at least two driverless transport vehicles are connected with one another communicatively in such a way that their respective destinations within the collective are coordinated and determined for the individual transport vehicles. To accomplish this, each driverless transport vehicle has a control unit, whereby the control units of the transport vehicles are connected to one another communicatively, without requiring the involvement of a higher-level control system, for the exchange of information for the coordinated and efficient determination of the destinations and the procedures for arriving at these destinations. In contrast, if a central control system is present, then it coordinates the destinations and also the travel paths of the driverless transport vehicles. Alternatively, each driverless transport vehicle can be embodied to determine its destination and travel path automatically. This can be achieved in particular by the driverless transport vehicle having a sensor system by which the textile machine promptly checks for empty spinning cans, wherein the sensor system is further communicatively connected to the control unit of the driverless transport vehicle and the control unit is embodied to evaluate and determine, based on the information detected by the sensor system, at which spinning position when and which action is due, for example the next action such as replacing the spinning. Alternatively or additionally, according to a further embodiment, this information can be transmitted by a control unit which is arranged outside the driverless transport vehicle and is communicatively connected to the control unit of the driverless transport vehicle.

The travelling drive of the transport vehicle is embodied to move it autonomously at least between the spinning machine delivering the fibre band and the spinning machine fed with fibre band and, in particular, to have the further advantage of determining its destination automatically, i.e. which position at which spinning machine is to be approached. Driverless transport vehicles are widely known. These are usually controlled in a collective, either centrally or individually, to travel to defined positions or locations. The driving unit of the driverless transport vehicle according to an embodiment of the present invention may be embodied accordingly. In a collective control system, for example, at least two driverless transport vehicles can be connected with one another communicatively in such a way that their respective destinations within the collective are coordinated and determined for the individual transport vehicles. To accomplish this, the driverless transport vehicle, according to an embodiment of the present invention, has a control unit for the travelling drive, whereby the control unit is connected communicatively to the control unit of a further driverless transport vehicle, without requiring the involvement of a higher-level control system, for the exchange of information for the coordinated and efficient determination of the destinations and the autonomous procedures for arriving at these destinations.

In an alternative embodiment, destinations and also travel paths of the driverless transport vehicle are coordinated centrally via a master control system. To control the travelling drive, as well as the autonomous manipulator unit (by which the at least one spinning can between the transport platform and the spinning machines is adjusted), these can be connected to a master control system according to this embodiment. This is a control unit remote from the transport vehicle, which can further be used for monitoring and controlling various production processes. The master control system can further be connected to the fibre band-supplying and/or the fibre band-fed spinning machine, whereby according to the latter embodiment, the driverless transport vehicle can be controlled in such a way that the fibre band provided in spinning cans at the fibre band-supplying spinning machine can be made available as required at the fibre band-fed spinning machine by the driverless transport vehicle, whereby production interruptions can be reliably prevented. The connection of the driverless transport vehicle and its units to be controlled with the master control system is established via a wireless data link, which ensures sufficient autonomy of the driverless transport vehicle.

As a further alternative, the driverless transport vehicle can be embodied in accordance with an embodiment to determine its destination and travel path automatically. This can be achieved in particular by the driverless transport vehicle having a sensor system by which a spinning machine is checked for promptly filled or empty spinning cans, the sensor system further being communicatively connected to the control unit of the driverless transport vehicle and the control unit being embodied to evaluate and determine, based on the information detected by the sensor system, when and which action is due, and at which spinning machine, as for example the collection of at least one filled spinning can or the replacement of an empty spinning can with a filled spinning can. Alternatively or additionally, according to a further embodiment, this information can be transmitted by a control unit which is arranged outside the driverless transport vehicle and is communicatively connected to the control unit of the driverless transport vehicle.

According to an embodiment, the transport vehicle comprises at least one control unit for controlling the autonomous driving unit and one control unit for controlling the autonomous manipulator unit, with these two operation control units being further communicatively connected to one another by cable or wirelessly. The arrangement of the control units for the driving unit and for the manipulator unit on the transport vehicle can be carried out as required and favours the fully autonomous functionality of the transport vehicle. It can thus, for example, travel automatically to defined positions within the textile factory by the control unit for the drive unit, in particular to defined workstations or positions of the spinning machine, whereby the defined position can be specified externally to the transport vehicle, for example by the master control system. Once the defined position has been reached, the manipulator unit can immediately start handling using the information about reaching the defined position from the operation control device of the driving unit or, alternatively or additionally, using data recorded by sensor systems arranged on the transport vehicle or at the destination to confirm that the defined position has been reached.

For moving the spinning cans between the transport platform and the spinning machines, i.e., among other things, for taking up the at least one spinning can filled with fibre band at the spinning machine delivering fibre band and for positioning the at least one spinning can at the spinning machine fed with fibre band, the driverless transport vehicle according to an embodiment of the present invention comprises the manipulator unit. Components of the manipulator unit are its gripper for gripping the at least one spinning can and its actuating device for positioning the gripper relative to the transport platform. To take up the at least one spinning can, the gripper is adjusted by the actuating device into a position in which it can grip the at least one spinning can by a corresponding adjustment of the gripper. The spinning can then subsequently be positioned in a defined way on the transport platform of the driverless transport vehicle by adjusting the actuating device once again. Following an adjustment or movement of the transport vehicle from the fibre band-delivering spinning machine to the fibre band-fed spinning machine, a defined displacement of the at least one spinning can from the transport platform into the area of influence of the fibre band-fed spinning machine takes place in reverse order, with the spinning can gripped by the gripper being positioned accordingly by the actuating device and released by an adjustment of the gripper.

The manipulator unit can be embodied by a collaborative robot, also known as a cobot, with a robot arm forming the actuating device and a robot hand forming the gripper. Such a cobot has the advantage that it can readily interact with an operator in the textile mill in a common environment without cages or guards, and without the safety precautions that would otherwise be employed, and can assist the operator in complex tasks that cannot be fully automated. In contrast to other robot devices, such cobots are equipped with sensor systems that cause the cobot to shut down if it comes into contact with defined obstacles. This can reliably prevent injuries to the operator.

The robot arm can be assembled in a modular articulated manner. In this way, the robot arm can be lengthened or shortened by at least one additional arm section as required, in order to be able to adjust the reach as needed. The modular articulated composition can be achieved, for example, by ball-and-socket-type couplings which, in a further manner, can have sliding contacts for passing information and/or the energy supply. Also, at least one arm section can have a retractable and extendible subsection, thereby enabling simplified reach adjustment. In a further manner, the gripper can be interchangeably attached to the robot arm.

According to an embodiment, the transport vehicle, in particular the manipulator unit, comprises at least one detection system, in particular an image processing system, of which a defined surrounding area of the transport vehicle and/or a defined working area of the manipulator unit can be monitored by sensors, in particular optically, and can further be monitored and recorded in a storable manner. Particularly, the detection system is arranged on the transport vehicle or on the manipulator unit in such a way that the working area, i.e. a handling area of the manipulator unit, in particular of the gripper, can be monitored or recorded. The detection system can be located near or on the gripper outside it. Further, a receiver unit of the detection system, for example an image capturing unit of the image processing system, may be arranged on an arm section supporting the gripper or on a joint connecting this arm section and the gripper. The arrangement of the image capturing unit is freely selectable. A feature of the arrangement of the image capturing unit is the possibility of monitoring the working area of the gripper, in which case the image capturing unit is arranged in such a way that an image capture central axis is incongruent with a holding axis of the gripper. A holding axis of the gripper is understood to be the axis which runs between gripping elements of the gripper and towards which at least one of the gripping elements moves in order to grip an object or an item in connection with the other gripping elements. In a gripping state of the gripper that grasps an object, the holding axis runs through the object. In an object-free state of the gripper, the holding axis runs in an area delimited by the gripping elements.

Furthermore, the sensing system can be communicatively connected to a control unit of the manipulator unit, wherein the control unit is embodied to autonomously control the manipulator unit based on information from the detection system. A knowledge base can be provided, which is communicatively connected to the control unit in such a way that the control unit compares information of the detection system with information stored in the knowledge base and controls the manipulator in a defined manner based on this comparison.

Furthermore, the detection system, alone or in combination with the control unit, can be embodied to interact with markers positioned in a defined manner in the working area of the manipulator unit. This means that the manipulator unit can be controlled to perform precisely executable handling operations within the marking area defined by the markings. Incorrect movements can thus be avoided as far as possible, as a result of which productivity can be increased.

The driverless transport vehicle according to an embodiment of the present invention allows autonomous personnel-independent supply of the spinning machines feeding and supplied with fibre band as required, so that a standstill due to a running-out of the spinning machine supplied with fibre band can be reliably avoided. The autonomous embodiment of the travelling drive and the manipulator unit makes it possible to completely dispense with operating personnel, both for adjusting the transport vehicle and for loading and unloading the at least one spinning can.

The embodiment of the actuating device in such a way that it can be used to move the gripper into a position for taking up and setting down the spinning can is basically freely selectable. According to a further development of an embodiment of the present invention, it is provided that the actuating device for adjusting the gripper is embodied for multi-axial displacement of the gripper relative to the transport platform and/or has a gripper arm which can be adjusted in an articulated manner relative to the transport platform.

In the case of the embodiment of the actuating device for multi-axis travel of the gripper, this can be embodied in such a way that the gripper can be placed in a defined area above the transport platform and next to it by suitable linear and/or rotating adjustment options of individual components of the actuating device relative to the transport platform. The embodiment of the actuating device for multi-axis travel of the gripper makes it possible to effect the position of the gripper using linear or rotary drives or a combination thereof, so that the actuating device can be manufactured in a simple and cost-effective manner.

In the case of a potential use of a gripper arm, this can be adjusted in an articulated manner relative to the transport platform so that the spinning can can be gripped and set down in a simple manner by the gripper. The use of a gripper arm also makes it possible to embody the actuator in a simple manner so that the spinning cans can be adjusted perpendicularly to the transport platform in such a way that they can be lifted over adjacent spinning cans or over obstacles in a simplified manner and reliably positioned. In particular, the use of a gripper arm allows the spinning can to be positioned in a large environment around the transport platform.

According to a further development of an embodiment of the present invention, a take-up unit is provided which is arranged on the transport platform and supports the actuating device mounted in a raised position relative to a surface of the transport platform. According to this embodiment of the present invention, a take-up unit, for example in the form of a frame or housing, is arranged on the transport platform, which further can extend perpendicular to the plane of the transport platform. In one area of the take-up unit, the distance of which from the transport platform can furthermore be greater than the height of the at least one spinning can, the actuating device is mounted on the take-up unit. The actuating device can thus be more compact in its embodiment.

According to a further embodiment, the actuating device has a cantilever which can be adjusted uniaxially relative to the transport platform, in particular also relative to the take-up unit, and on which the gripper is mounted so as to be adjustable uniaxially relative to the cantilever.

The cantilever can be arranged on the take-up unit and further can extend from the take-up unit in a direction over the transport platform so that the gripper, which can be adjusted along the cantilever, can be adjusted over the entire extension of the transport platform in the longitudinal direction of the cantilever. The simultaneous adjustability of the cantilever relative to the take-up unit (in particular transversely to the longitudinal direction of the cantilever, the adjustability being embodied in such a way that the gripper can thereby be positioned not only transversely to the cantilever over the entire extent of the transport platform, but also beyond it, in order to enable a spinning can to be deposited or taken up from an area adjacent to the transport platform) ensures that the gripper can be arranged at any position necessary for the operation of the transport vehicle. A combination of the (in particular linear) adjustability of the cantilever relative to the take-up unit and the (in particular linear) adjustability of the gripper relative to the cantilever ensures reliable positioning of the gripper at a desired position for taking up and setting down a spinning can, for which purpose the gripper can also be arranged on the cantilever so as to be adjustable perpendicularly to the plane of the transport platform.

In the case of the use of a gripper arm provided in accordance with a further development of an embodiment of the present invention, it is provided in accordance with a further development that the gripper arm has at least a first gripper arm body and a second gripper arm body, which are connected to one another in an articulated manner, the first gripper arm body being connected to the transport platform or the take-up unit in an articulated manner at its end opposite the second gripper arm body, and the second gripper arm body being connected to the gripper in an articulated manner at its end opposite the first gripper arm body.

According to this embodiment of the present invention, the gripper arm has at least two segments, namely the first gripper arm body and the second gripper arm body. The two gripper arm bodies are connected to one another in an articulated manner, in particular in such a way that they can be pivoted about a common axis extending perpendicular to the longitudinal axis of the first gripper arm body and second gripper arm body. The first gripper arm body is in turn connected by its end opposite the second gripper arm body in an articulated manner to the transport platform, and can be connected to the take-up unit connected to the transport platform and extending perpendicularly thereto, with the articulated connection of the first gripper arm body to the take-up unit or the transport platform being embodied in such a way that the first gripper arm body can be pivoted about a longitudinal axis extending both perpendicularly and parallel to the transport platform.

The articulated connection of the first gripper arm body to the take-up unit or to the transport platform, and the articulated connection of the first gripper arm body to the second gripper arm body, allow the gripper arranged at the end of the second gripper arm body opposite the first gripper arm body to be arranged in any position relative to the transport platform, and also adjacent to the transport platform, depending on the length of the first and second gripper arm bodies. The gripper is in turn connected to the end of the second gripper arm body opposite the first gripper arm body in an articulated manner, the joint axis extending parallel to the transport platform, so that the gripper can be aligned parallel to the transport platform independently of the position of the first and second gripper arm bodies, so that reliable detection and positioning of the at least one spinning can can take place.

A complementary articulated connection of the gripper to the second gripper arm body, whereby the gripper can be connected to the second gripper arm body so as to be rotatable about a longitudinal axis extending perpendicularly to the transport platform, furthermore makes it possible to position the gripper in such a way that its gripper elements cannot come into contact with a fibre band end projecting from the spinning can, for example, whereby this may become damaged. Also, by this embodiment of the present invention, the gripped spinning can can be easily adjusted about its longitudinal axis, allowing the spinning can to be aligned according to the positioning of the fibre band end.

According to a further development of an embodiment of the present invention, the gripper has three gripper elements adjustable relative to one another between a release position releasing the spinning can and a holding position locking the spinning can in place. The use of three gripper elements enables reliable gripping of the spinning can, in particular the spinning can embodied as a round can, whereby the arrangement of the gripper elements to one another as well as the number of adjustable gripper elements are basically freely selectable. According to another embodiment of the present invention, it is provided that the three gripper elements are evenly distributed over a circumference, and at least one of the gripper elements is arranged on the gripper so as to be adjustable in radial direction. According to this embodiment of the present invention, all three gripper elements are evenly distributed over the circumference in the radial direction, i.e. arranged on the gripper at a distance of 120° in circumferential direction. An adjustment of the at least one gripper element in radial direction makes it possible, in particular for round cans, which have a circular cross-section, to be able to gripped particularly reliably by the gripper elements and held in the holding position and released in the release position, wherein the gripper elements in the holding position are embodied to come into contact on the outside with a jacket surface of the spinning can and to hold it in a clamping manner. According to a further embodiment, the gripper elements are adjustable in length, i.e. embodied with a variable length in a direction orthogonal to the circumferential direction. This means that the length of the gripper elements can be adjusted as required, for example to increase the clamping surface for securely holding a spinning can. Further more than one gripper element, and even all gripper elements, can be arranged and embodied to be adjustable in radial direction on the gripper, whereby the handling of the spinning can can be improved.

According to an alternative embodiment of the present invention, the gripper has exclusively three gripper elements adjustable relative to one another between the release position releasing the spinning can and the holding position locking the spinning can in place. In particular, one gripper element is fixed to the gripper and the other gripper element is arranged so that it can be adjusted linearly in the direction of and in the opposite direction to the fixed gripper element on the gripper. Each gripper element can have at least one contact surface for contacting the spinning can side wall. The dimensions of the contact surfaces are selected in such a way that the spinning can can be reliably supported by the clamping effect of the contact surfaces when contact is made. In particular, the contact surfaces have a congruent embodiment to the spinning can surface contour in order to be able to lie flush against the spinning can surface over the defined surface section of the contact surface. Further, at least one of the two gripper elements has at least two contact surfaces for contacting the spinning can side wall, the two contact surfaces being at a defined distance from one another. The gripper element can thereby be embodied in a less expensive fashion. The other gripper element may comprise at least one contact surface for contacting the spinning can side wall. This also allows at least three-point contacting of the spinning can in order to be able to reliably detect it. The more contact surfaces are provided, the better the gripper can grip the spinning can. An embodiment in which each of the two gripper elements have two spaced-apart contact surfaces can be employed. This enables a constructively favourable embodiment of the gripper while taking into account a reliable gripping and handling of the spinning can by the gripper.

A contact surface is understood to be a surface section of the gripper element which is suitable for enabling contact with the element to be contacted, in this case the spinning can. The contact surface can be freely selected in terms of its dimensions, taking into account the contact force that can be applied to the spinning can such that the spinning can can be handled, in particular carried, by the manipulator unit without causing damage. In particular, the contact surface has a static-friction surface structure to ensure reliable handling by the manipulator unit. The static-friction surface structure can be embodied with the contact surface or applied to it, in particular in a non-destructively replaceable manner, for example in the form of a flat structure such as a pad.

According to an embodiment, the linearly adjustable gripper element is adjustable via a spindle drive. In particular, the spindle drive is arranged between the stationary and the linearly adjustable gripper elements in the area of an intermediate carrier section of the gripper, which carries an end section of each of the two gripper elements. The carrier section can in particular have a recess through which the linearly adjustable gripper element projects in order to be guided in a linearly adjustable manner.

According to an embodiment, a signalling device is arranged on one of the gripper elements and embodied to signal contact between the two gripper elements and the spinning can. The signalling device can be communicatively connected to a control unit, in particular to the control unit for controlling the manipulator unit, so that a gripping movement of the movable gripper element or elements is stopped as soon as they make with contact the spinning cans. For example, the signalling device can be a proximity switch or a contact switch. The latter can in particular be arranged in a contact surface of the gripper element.

According to a further development of an embodiment of the present invention, it is further provided that the transport vehicle, the actuating device and/or the gripper comprise a detection unit for detecting a position of the spinning can and/or of a fibre band end arranged in and/or on the spinning can. The use of a detection unit makes it possible to detect the position of the fibre band end in or on the spinning can and to arrange the gripper accordingly on the spinning can in such a way that the fibre band end is not damaged by a gripper element of the gripper. In addition, knowledge of the position of the fibre band end makes it possible to arrange the spinning can on a fibre band-fed spinning machine in such a way that the fibre band end is positioned on the spinning machine in a position intended for automated take-up. The detection unit can be camera-based, e.g. by the detection system described above, laser-based and/or sensor-based in its embodiment, whereby a particularly reliable detection of the position of the fibre band end in the spinning can can be ensured. For example, according to another embodiment, the spinning can interacting with the transport vehicle may have a coloured ring or section around its outer circumference, which is arranged below the spinning can opening or the spinning can rim. The colour of the ring or the section can be selected in such a way that the colour of the end of the fibre band ribbon contrasts strongly with the colour of the ring or the section. For example, fibre bands made of cotton material have a light colour. Accordingly, a dark-coloured ring or section can be suitable for such fibre bands. A fibre band end hanging down over the spinning can rim on the outside, adjacent to the coloured ring or the coloured section, can thus be readily detected by the detection unit.

According to an embodiment, the detection unit comprises a transmitter unit and a receiver unit, which is arranged to interact with the transmitter unit in such a way that a region of the spinning can acted upon by the transmitter unit can be monitored and sensed by the receiver unit. The transmitter unit may be a light transmitter unit such as an Infrared transmitter unit or a laser unit. The receiver unit can be, for example, a light-receiving unit, in particular an image processing unit, which is embodied to detect the light emitted by the light-emitting unit and reflected by the spinning can. The image processing unit can be arranged and embodied to monitor a defined surface section of the spinning can, in particular near an edge area adjacent to the spinning can opening, for the presence and/or absence of the fibre band end. The light-emitting unit can be embodied and arranged to apply light of a defined wavelength to the surface section of the spinning can to be monitored by the image processing unit.

Further, the transmitter unit and the receiver unit can be arranged at a distance from one another along a vertical axis of the transport vehicle with or without horizontal offset along the vertical arrangement axis or to one another. Furthermore, the transmitter unit and also the receiver unit can be arranged in the take-up unit. Alternatively, the transmitter unit can be arranged in the housing of the transport vehicle below the take-up unit.

Particularly, the transmitter unit can be arranged along the vertical axis below the receiver unit with or without horizontal offset relative to the receiver unit and is embodied as a light transmitter unit in such a way that a horizontally running line of light of defined length and thickness can be radiated obliquely upwards, i.e. in the direction of the horizontal plane of arrangement of the receiver unit, onto the spinning can. The angle of reflected beam to the horizontal plane of arrangement of the light-emitting unit can be selected from the angular range of 15° to 85° inclusive, more preferably from 20° to 60° inclusive. The lower arrangement of the light-emitting unit with view of the receiver unit causes a parabolic imaging of the line of light on the spinning can surface near the spinning can opening. This is particularly advantageous for round cans, i.e. spinning cans with a round cross-section in a horizontal plane, as the lowest point of the parabola is congruent to the centre of the spinning can along a horizontal axis of the spinning can.

The receiver unit is arranged and embodied to detect the imaged, parabolic line of light and, in particular, to provide it to the control unit for controlling the manipulator unit. In particular, the receiver unit may be an image processing unit, i.e. a camera. The detected light signals are evaluated by the control unit to determine at least an exact spinning can position at the textile machine and further possibly also a position of a fibre band end hanging down from the spinning can rim, so that the spinning can can be reliably handled by the manipulator unit without affecting the fibre band end.

Furthermore, a second light-emitting unit can be provided, which is in particular arranged in the plane of arrangement of the receiver unit. Further, the second light-emitting unit can be arranged immediately adjacent to the receiver unit and in the vertical plane of arrangement of the light-emitting unit. In other words, the light-emitting unit and the second light-emitting unit are positioned one above the other along the vertical axis without any horizontal offset from one another, with the light-emitting unit positioned below the second light-emitting unit. The receiver unit is placed above the light-emitting unit with horizontal offset along the vertical axis with respect to the light-emitting unit. This embodiment and arrangement favours, in addition to the exact position detection of the spinning can, an improved detection of at least the position of the fibre band end and the length of the fibre band end hanging down, starting from the spinning can rim. The detected light signals are evaluated by the control unit to determine an exact spinning can position at the textile machine as well as an exact position of the fibre band end on the spinning can, so that the spinning can can be reliably handled by the manipulator unit without affecting the fibre band end.

According to a further embodiment of the present invention, it is provided that the control unit of the manipulator unit is arranged in, on or on the take-up unit. According to this embodiment of the present invention, the take-up unit is not only used to mount the actuating device and the gripper, but is also embodied to accommodate or carry a control unit or control electronics of the manipulator unit, possibly of the actuating device, in particular of the gripper. Furthermore, it is possible to use the take-up unit for the arrangement of further components, e.g. a communication unit for the connection of the driverless transport vehicle with the master control system as well as a control unit of the travelling drive, where they are easily accessible in case of a technical defect.

According to a further embodiment, the transport vehicle has a control unit by which an operator can at least influence the interaction of the manipulator unit. The operating unit is connected communicatively to the control unit for that purpose. Further, the control unit can be communicatively connected to the detection system in order to be able to undertake settings in accordance with requirements. The operating unit can be integrated into the take-up unit, arranged on it, in particular on the take-up unit, whereby the arrangement of the operating unit is such that it is accessible to the operator. For example, according to the integrated arrangement, the control unit can be concealed but accessible via a movable cover unit. In particular, the control unit can thus be integrated into the receiver unit in such a provided way that it can be extended out of the receiver unit, via the movable, for example folded-away, cover unit.

According to another embodiment of the present invention, it is further provided that the transport vehicle has a pushing apparatus with a pusher body which can be brought into engagement with the spinning can and can be adjusted relative to the transport platform between a starting position and an end position for displacing the spinning can in the same direction as the bottom.

By the pusher body, it is possible to move the spinning can, which is set down by the gripper, to the correct position. For example, it is possible to remove a spinning can from the transport platform, position it next to the transport platform and then move it by the pusher body into the position required for operating a fibre band-fed spinning machine. The use of a pusher body thereby ensures exact positioning of the spinning can, even in the event that the gripper cannot set the spinning can down in the intended position.

According to another embodiment of the present invention, it is thereby provided that the pusher body has a coupling unit for releasable, tension-resistant connection to the spinning can. According to this embodiment of the present invention, not only is displacement possible by the pusher body applying a pressure to the spinning can: the coupling unit also makes it possible to connect the spinning can and the pusher body in such a way that the pusher body can also transmit tensile forces to the spinning can, so that, for example, in the case of a necessary removal of an empty spinning can at a fibre band-fed spinning machine, the spinning can can be pulled from its position on the spinning machine via the coupling unit and moved into a position at which it can be gripped by the gripper.

The embodiment of the coupling unit for releasable, tension-resistant connection to the spinning can is basically freely selectable. According to another embodiment of the present invention, it is provided that the coupling unit has a vacuum unit, a magnetically, in particular electromagnetically, acting and/or a latch-connecting retaining device.

In the case of the use of a vacuum unit, the vacuum between the coupling unit and a jacket surface of the spinning can causes a tension-resistant, easily releasable connection, so that the spinning can can be pulled by the pusher body. In the case of the use of a magnetic, in particular an electromagnetic retaining device, a tension-resistant connection can be established via the magnetic connection, whereby an electromagnetically acting retaining device enables separation of the coupling unit from the spinning can in a particularly simple manner via suitable activation and deactivation. The spinning can can have a ferromagnetic material, e.g. in the form of a metal ring, for magnetic, in particular electromagnetic, connection, e.g. at a corresponding section of the spinning can. The metal ring can furthermore have a colour that differs from the fibre band as described above in order to provide a high-contrast separation of a fibre band end hanging over the spinning can rim with respect to the spinning can.

In principle, the arrangement of the pusher body at the transport vehicle is basically freely selectable. The arrangement of the pusher body on the transport vehicle is such that the spinning can can be contacted by the pusher body at its vertical centre or in an area around its vertical centre with respect to the spinning can height between the spinning can bottom and the spinning can rim. Furthermore, the range can extend from ¼ to ¾ of the height of the spinning can, starting from the bottom of the spinning can. Furthermore, the range can extend from ⅓ to ⅔ of the height of the spinning can, starting from the bottom of the spinning can. In this way, a possible danger of tipping over when pushing or pulling the spinning can can be avoided to the greatest extent possible. The spinning can can be moved, for example, by a defined process with simultaneous contact of the pusher body with the spinning can.

According to a further embodiment, the pusher body is arranged on a pusher body support, which is connected to the transport platform, for example, and which further has a drive unit for linear adjustment of the pusher body relative to the pusher body support. The linear adjustment allows a defined positioning of the spinning can on the spinning machine, even when the transport vehicle is at a standstill.

According to another embodiment of the present invention, there is provision for the pusher body to be arranged on the gripper. This embodiment of the present invention makes it possible to dispense with a drive for the pusher body, for example by moving the transport vehicle and/or a separate drive in the case of arrangement on the transport platform. For the defined positioning of the spinning can by the pusher body, according to this embodiment, an adjustment of the gripper by the actuating device is sufficient, which enables a reliable displacement of the spinning can in case the pusher body is in contact with it.

Particularly, the pusher body is arranged on the gripper embodied with two gripper elements in accordance with the embodiment described above. Particularly, the pusher body is placed on the fixed gripper on a side of the fixed gripper element facing away from the contact surface. Alternatively, the pusher body can be arranged on the linearly adjustable gripper element on a side facing away from the contact surface. This embodiment is advantageous to that effect in that the spinning can can be positioned very precisely via the linear adjustment of the linearly adjustable gripper element.

According to an embodiment, the transport vehicle comprises at least one distance sensor arranged and embodied to detect a distance to the spinning can. This allows the spinning can to be handled more reliably and in an improved manner by the transport vehicle, in particular the manipulator unit. Further, the or a distance sensor can be arranged on the gripper. This allows the handling of the spinning can by the manipulator unit to be improved. In particular, the distance sensor is an ultrasonic sensor.

In principle, the embodiment of the transport platform is basically freely selectable. According to another embodiment of the present invention, it is provided that the transport platform is embodied to accommodate an even number of spinning cans, in particular at least two, possibly at least four, and even at least six or eight spinning cans. This embodiment of the driverless transport vehicle ensures a good transport capacity with a simultaneously compact construction, so that the transport vehicle can be manoeuvred particularly well and into a corresponding position in relation to the fibre band-supplying and fibre band-fed spinning machines.

Furthermore, the transport platform can be embodied to be turned or rotated like a rotary plate. This allows a parking position of the transport platform to be moved to a handling position that is favourable for the manipulator unit. A parking position is to be understood as the position on the transport platform on which a spinning can can be or is parked.

According to an embodiment, the transport platform can have two platform units, of which at least one can be embodied to be rotatable. In an embodiment, the platform unit can be a rotary plate-type platform unit. Also, the manipulator unit can be arranged between the two platform units. This allows the parking positions of each platform unit to be reached in an improved manner by the manipulator unit.

The driverless transport vehicle according to an embodiment of the present invention is suitable for carrying out a can change on a fibre band-fed spinning machine. In accordance with a further aspect of an embodiment of the present invention, a process for replacing a spinning can on a spinning machine by the driverless transport vehicle is proposed in accordance with an embodiment of the present invention. The method comprises in particular the process steps for moving the driverless transport vehicle loaded with at least one spinning can filled with fibre band to the spinning machine. At the spinning machine, the transport vehicle positions itself in front of the spinning can to be replaced. The spinning can to be replaced is then moved by the driverless transport vehicle from an operating position to a take-up position at a distance from the operating position. The operating position of the spinning can is the position on the spinning machine where the fibre band can be drawn off unhindered from the spinning can for further processing by the spinning machine. The take-up position is a position where the spinning can to be replaced can preferably be picked up by the driverless transport vehicle or another unit.

According to another embodiment of the present invention, it may be necessary, before the step of moving the spinning can to be replaced, to first move a further spinning can arranged between the spinning can to be replaced and the transport vehicle into a further operating position by the driverless transport vehicle from its further operating position into a waiting position different from the operating positions and the take-up position. This is then necessary, for example, if the spinning machine has two spinning cans arranged one behind the other on one longitudinal side of the machine transverse to its longitudinal direction for feeding two adjacent workstations of the spinning machine and the rear spinning can more distant from the transport vehicle is to be replaced.

After the additional spinning can has possibly been moved by the driverless transport vehicle into the waiting position and the spinning can to be replaced has been moved by the driverless transport vehicle into the take-up position, the additional spinning can can be first moved by the driverless transport vehicle into the operating position, i.e. into the position where the spinning can to be replaced was previously located during operation of the spinning machine.

According to an embodiment of the invention, the manipulator unit takes up a spinning can filled with fibre band from the transport platform and sets it down next to the transport vehicle. This step can optionally also take place before the spinning can to be replaced is brought into the take-up position and, if necessary, before the further spinning can is brought into the operating position. The filled spinning can can be set down and made available in a position that does not obstruct the transfer of the spinning can to be replaced and other spinning cans into their respective positions.

Before or after taking up and setting down the filled spinning can, the spinning can to be replaced can be set down on the transport platform by the manipulator unit. The taking up and setting down of the spinning can to be replaced on the transport platform by the manipulator unit can take place before or after moving the filled spinning can into the free operating position, which can also be the further operating position, depending on the number of spinning cans to be moved. For reasons of space, however, the spinning can to be replaced can first be moved into the take-up position and then to take up and set down the filled spinning can next to the transport vehicle. Furthermore, for reasons of productivity, after the filled spinning can has been set down, it can be first moved to the free operating position, i.e. before the spinning can to be replaced is picked up and set down on the transport platform, so that the time interruption of production at the affected workstation of the spinning machine can be kept to a minimum.

Before, in the course of, or after the filled spinning can is brought into the free operating position, the filled spinning can can be aligned in such a way that the fibre band end of the filled spinning can hanging down over the spinning can rim can be directly grasped by a service unit of the spinning machine and fed to the relevant workstation for resumption of production. This can further reduce the interruption time.

### BRIEF DESCRIPTION OF THE DRAWINGS

Embodiment examples of the present invention are explained below with reference to the drawings. In the drawings:

FIG. 1 shows a schematic, perspective side view of a first embodiment of a driverless transport vehicle;

FIG. 2 shows a schematic, perspective top view of the driverless transport vehicle from FIG. 1 with a spinning can held by a gripper;

FIG. 3 shows a schematic, perspective side view of the transport vehicle from FIG. 1 with a spinning can release gripper;

FIG. 4a shows a schematic illustration of a top view of a second embodiment of a driverless transport vehicle;

FIG. 4b shows a schematic illustration of a side view of the driverless transport vehicle of FIG. 4a;

FIG. 5a shows a schematic illustration of a top view of a third embodiment of a driverless transport vehicle;

FIG. 5c shows a schematic illustration of a top view of a third embodiment of a driverless transport vehicle;

FIG. 5b shows a schematic illustration of a side view of the driverless transport vehicle of FIG. 5a;

FIG. 6 shows a schematic illustration of a perspective side view of a third embodiment of a driverless transport vehicle;

FIG. 7 shows a schematic illustration of a top view of a fourth embodiment of a driverless transport vehicle; and

FIG. 8 shows a schematic illustration of a spinning can replacement process.

### DETAILED DESCRIPTION

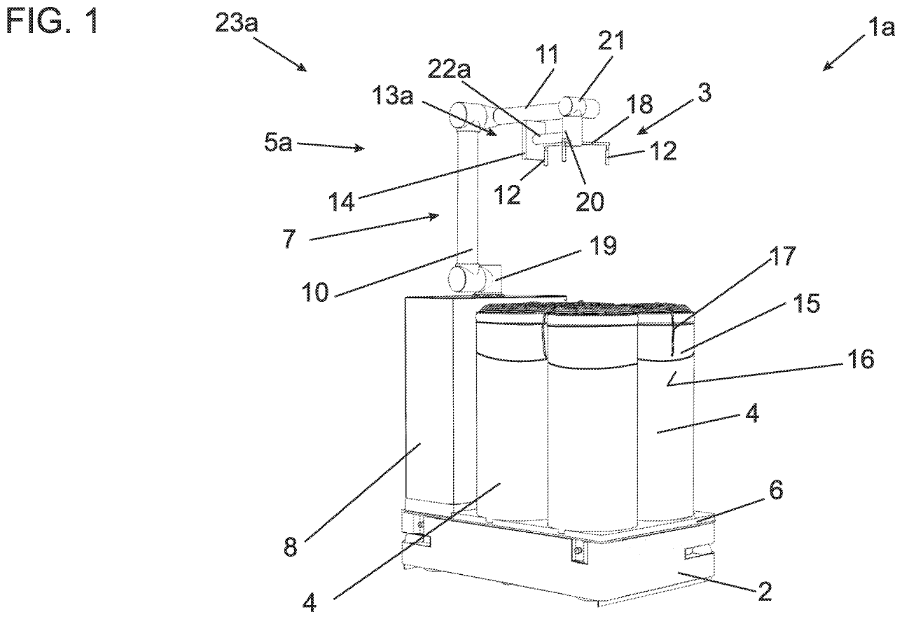

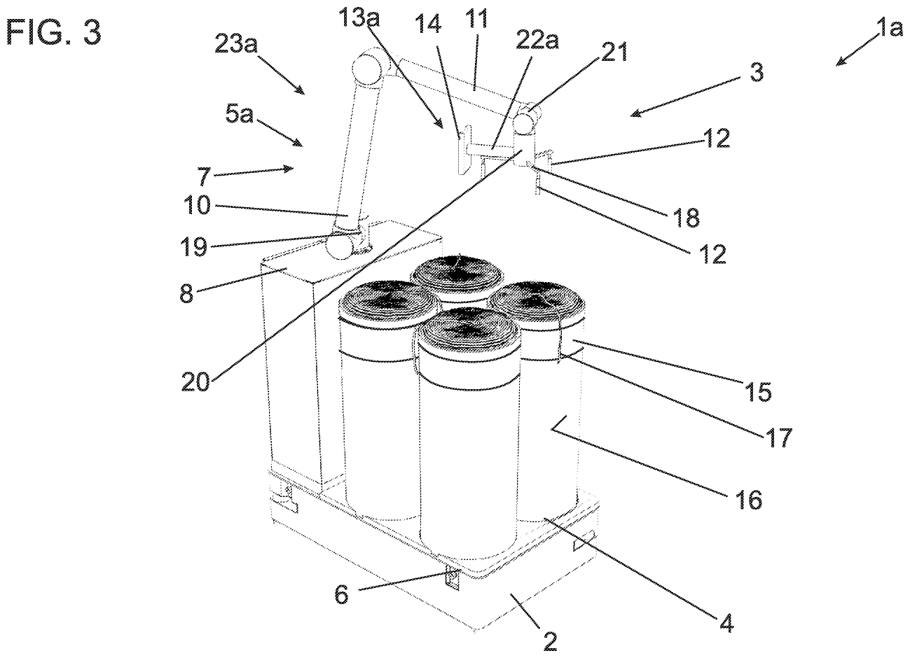

A driverless transport vehicle 1a shown in FIGS. 1, 2 and 3 has a travelling drive 2 and a transport platform 6 arranged on the travelling drive 2, which is embodied to accommodate four spinning cans 4 in the form of round cans.

Adjacent to the transport platform 6 on the outside, the transport vehicle 1a also has a take-up unit 8 extending perpendicularly to the plane of the transport platform 6, which serves, among other things, to accommodate control electronics of an actuating device 5a of a manipulator unit 23a and to accommodate a vehicle control which can be connected to a central master control system, wherein the central master control system is a control unit which monitors and controls, among other things, the entire production process of a spinning machine which delivers fibre band and is fed with fibre band and which is not shown here.

At the end facing away from the transport platform 6, a gripper arm 7 of the actuating device 5a is in articulated alignment at the take-up unit 8. The gripper arm 7 has a first gripper arm body 10 and a second gripper arm body 11, the first gripper arm body 10 being connected to a gripper arm support 19 arranged on the take-up unit 8 so as to be able to pivot about a pivot axis extending parallel to the plane of the transport platform 6, the gripper arm support 19 in turn being rotatable about a longitudinal axis extending perpendicular to the plane of the transport platform 6.

At its end opposite the gripper arm support 19, the first gripper arm body 10 is connected in an articulated manner to one end of the second gripper arm body 11, the first gripper arm body 10 and the second gripper arm body 11 being connected so as to be able to be pivoted relative to one another about a pivot axis extending parallel to the plane of the transport platform 6. At its end opposite the first gripper arm body 10, the second gripper arm body 11 has a gripper retainer 21 of a gripper 3, wherein the gripper retainer 21 and the second gripper arm body 11 are in turn pivotally connected about a pivot axis extending parallel to the plane of the transport platform 6, so that a gripper base body 20 extending perpendicular to this pivot axis can be aligned perpendicular to the plane of the transport platform 6 independently of the relative position of the first gripper arm body 10 to the second gripper arm body 11.

Three support struts 18 extend in a plane and perpendicularly from the gripper base body 20, which are arranged at a distance of 120° from one another in circumferential direction. A gripper element 12 extending perpendicularly to the support struts 18 is arranged on each of the support struts 18, each of which is adjustable in radial direction along the support struts 18 between a holding position gripping the spinning cans 4 and a release position releasing them.

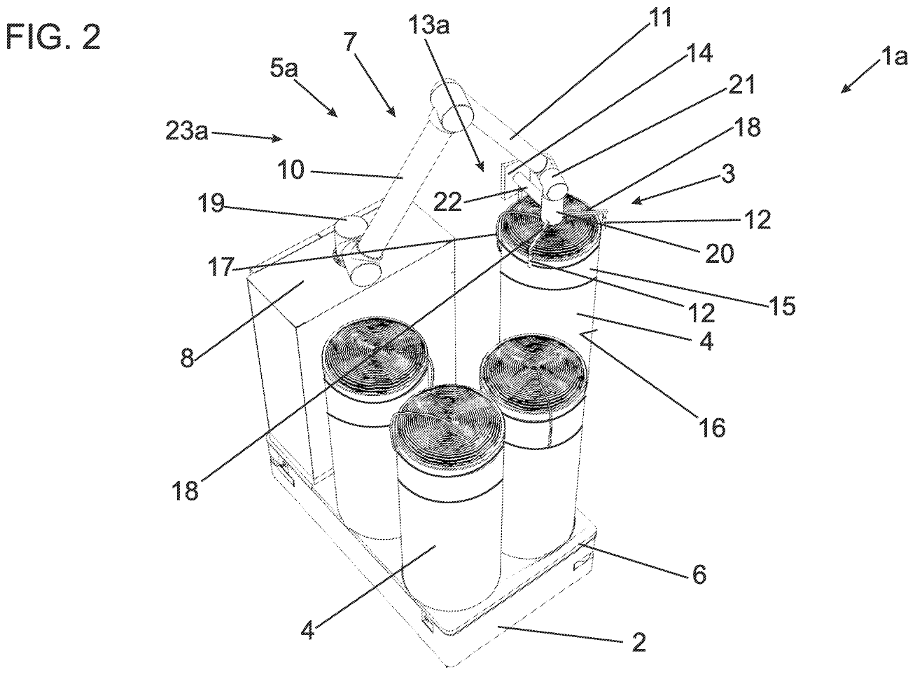

In order to grasp a spinning can 4, the gripper 3 is adjusted by an adjustment of the gripper arm 7 into a position in which the spinning can 4 can be grasped on the outside at its upper end by a relative displacement of the gripper elements 12 to one another (cf. FIG. 2). By a further adjustment, the spinning can 4 can then be lifted off the transport platform 6 and placed in the area of a fibre band-processing spinning machine, as shown in FIG. 2.

Due to a rotatability of the gripper base body 20 with respect to the gripper retainer 21, it is possible both to align the gripper elements 12 in circumferential direction with respect to the spinning can 4 and to rotate the gripped spinning can 4 about its longitudinal axis. This makes it possible to align the spinning can 4 according to the position of the fibre band end 17 with respect to the fibre band-fed spinning machine.

For the final displacement of the spinning can 4, a pushing apparatus 13a is used, which comprises a pusher body 14, which is connected to the gripper base body 20 via a pusher body support 22a. After the spinning can 4 has been set down next to the transport platform 6, the spinning can 4 can then be moved into its intended position by the pusher body 14 resting against the jacket surface 16 of the spinning can 4 by adjusting the gripper arm 7. In an embodiment not shown here, the pusher body 14 can also be of electromagnetic embodiment, so that when the electromagnetic pusher body 14 is activated, it establishes a tension-resistant connection with a metal ring 15 arranged on the jacket surface 16 in the area of an upper end of the spinning can 4, so that the spinning can 4 can then also be pulled out of its position by an adjustment of the gripper arm 7.

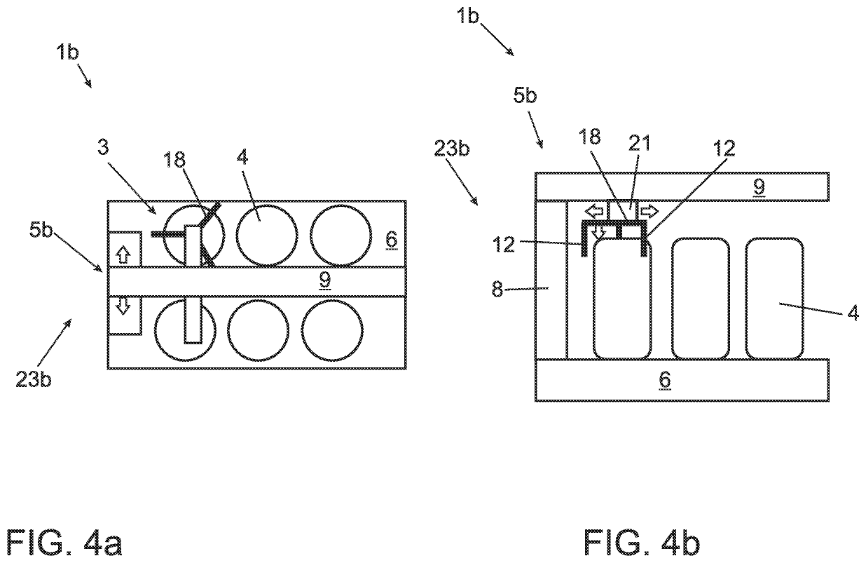

FIGS. 4a and 4b show a schematic illustration of a further embodiment of a transport vehicle 1b. In contrast to the transport vehicle 1a illustrated in FIGS. 1 to 3, this vehicle is embodied to accommodate six spinning cans 4 in the form of round cans. Furthermore, the actuating device 5b of the manipulator unit 23b of the transport vehicle 1b shown in FIGS. 4a and 4b comprises a cantilever 9 extending in longitudinal axis direction over the transport platform 6, which is adjustably arranged on the take-up unit 8 transversely to the longitudinal axis direction of the cantilever 9. The gripper 3 is in turn adjustable in the longitudinal axis direction of the cantilever 9, so that by a combination of the linear adjustability of the cantilever 9 relative to the take-up unit 8 and the linear adjustability of the gripper 3 relative to the cantilever 9, the gripper 3 can be moved to any position relative to the transport platform 6 for taking up a spinning can 4. The adjustment possibilities of the cantilever 9 in relation to the take-up unit 8 are embodied in such a way that after the spinning can 4 has been gripped by the gripper 3, the spinning can 4 can be moved laterally beyond the transport platform 6 and set down in an area adjacent to the transport platform 6. For this purpose, the gripper 3 is also connected to the cantilever 9 so that it can be adjusted perpendicularly to the transport platform 6.

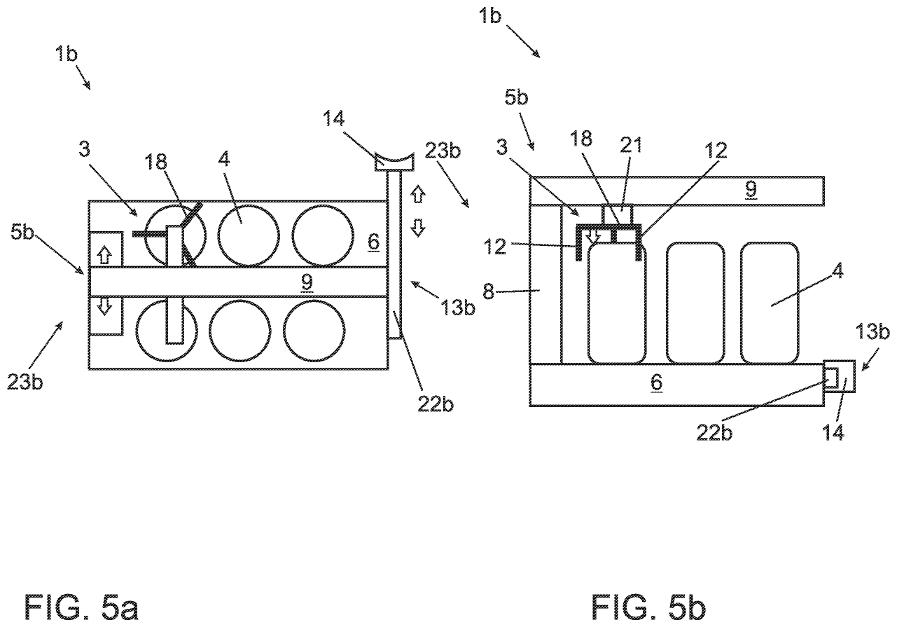

The transport vehicle 1b illustrated in FIGS. 5a and 5b is identical to the transport vehicle illustrated in FIGS. 4a and 4b, but additionally has a pushing apparatus 13b in the area of the transport platform 6, in which the pusher body 14 can be adjusted in the longitudinal axis direction of the pusher body support 22b, which is connected to the transport platform 6, so that a spinning can 4 arranged on the bottom can be displaced with this pushing apparatus 13b.

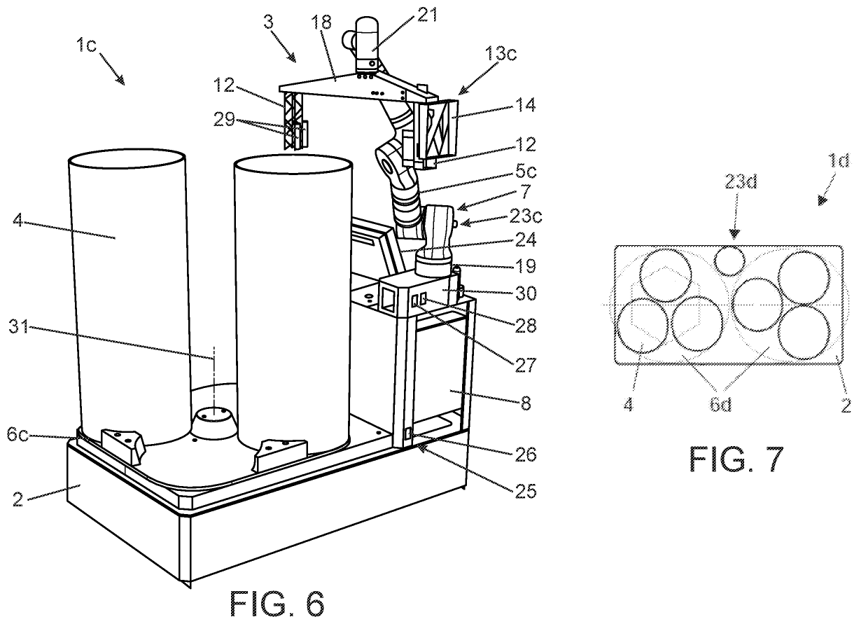

FIG. 6 shows a schematic illustration of a perspective side view of an additional embodiment of a driverless transport vehicle 1c. In contrast to the transport vehicle 1a illustrated in FIGS. 1 to 3, the transport platform 6c is embodied to be able to rotate around its central axis 31. In this embodiment, four parking positions 32 for the spinning cans 4 are provided, equally distributed around the central axis 31. The illustration shows the parking of two spinning cans 4 arranged opposite one another, while the parking positions in between in the direction of rotation of the transport platform 6c are free. The transport platform 6c is embodied to rotate both clockwise and anticlockwise. The rotatable embodiment of the transport platform 6c enables a spinning can 4 to be removed or a parking position for parking a spinning can 4 on the transport platform 6c to be delivered directly to the manipulator unit 23c.

The transport vehicle 1c also differs in the embodiment of the manipulator unit 23c with its actuating device 5c and the gripper 3 coupled thereto. The manipulator unit 23c is arranged on a platform 30, which is in turn arranged on an upper side of the take-up unit 8. This allows the gripper arm support 19 to be dimensioned smaller in height. The actuating device 5c is embodied with four axes in order to be able to move the gripper 3 more precisely in space. The gripper 3 is embodied with two gripper elements 12, whereby one of the two gripper elements 12 is arranged in a fixed position and the other gripper element 12 is arranged in a linearly adjustable manner along a support strut 18 carrying the gripper elements 12, in particular at the end thereof. The support strut 18 is rotatably supported by a gripper retainer 21. The adjustable gripper element 12 is shown in FIG. 6 in an end position in which the gripper 3 has the largest opening width between the two gripper elements 12. The adjustable gripper element 12 is linearly adjustable by an actuating drive, in particular a spindle drive, arranged in the support strut 18, in the direction of the stationary gripper element 12 and in a direction opposite thereto up to the end position shown.

Both gripper elements 12 have two contact surfaces 29 on their sides facing one another, which are embodied and arranged for contacting the side wall of the spinning can 4. The contact surfaces 29 arranged on the linearly adjustable gripper element 12 are illustrated here. The contact surfaces 29 comprise flat structures not shown here which have static friction structures, which are attached to the respective contact surfaces 29 in a non-destructively replaceable manner, in order to be able to grip the spinning can 4 by the manipulator unit 23c in an improved manner and to carry it in a clamping manner via the static friction effect.

The stationary gripper element 12 comprises, on its side facing away from the contact surfaces 29, a pushing apparatus 13c with a pusher body 14 which is fixedly attached to the stationary gripper element 12. The pushing apparatus 13c is embodied as a vacuum system, whereby the pusher body 14 embodies a vacuum box with a circumferential sealing lip which can be applied in a sealing manner to the surface of the side wall of the spinning can 4. By applying a vacuum, the spinning can 4 can be reliably attached to the pusher body 14 and displaced in an improved and reliable manner for exact positioning in a defined manner. In this embodiment, the vacuum source is arranged in the take-up unit 8, wherein the vacuum line leading from the vacuum source to the pusher body 14 according to this embodiment is arranged within the actuating device 5c, the coupled gripper 3 and its support strut 18. The same applies to the electrical cables for supplying the actuating drive with power and control signals.

The linearly adjustable gripper element 12 has a signal transmitter, not shown here, between its two contact surfaces 29 for signalling contact with the spinning can 4. The signal transmitter can be a proximity switch or a contact switch. As soon as the signal transmitter dispatches its signal, a feeding movement of the linearly adjustable gripper element 12 is stopped in order to prevent damage to the spinning can 4, for example due to excessive pressure.

The gripper 3 is further provided with a distance sensor, not shown here, which in this embodiment is arranged adjacent to the pusher body 14. The distance sensor is embodied and arranged to measure a distance between the gripper 3, in particular the pusher body 14, and the spinning can 4, so that the gripper 3 can be controlled in suitable fashion. The distance sensor can for example be an ultrasonic sensor.

The transport vehicle 1c is further equipped with a detection unit 25 for detecting a position of the spinning can 4 and for detecting a fibre band end 17 hanging down from the spinning can rim. The detection unit 25 comprises a first light-emitting unit 26, a second light-emitting unit 27 and a receiver unit 28. The first light-emitting unit 26 is arranged in the take-up unit 8 in a lower section and the second light-emitting unit 27 is arranged in the take-up unit 8 along a vertical axis of the take-up unit 8 in an upper section of the take-up unit 8 above the first light-emitting unit 26. The receiver unit 28 is positioned in a horizontal plane of arrangement of the second light-emitting unit 27 adjacent thereto in the take-up unit 8. The first 26 and second light-emitting units 27 are each embodied to emit a horizontal line of light of defined horizontal length and vertical thickness, the line of light emitted by the first light-emitting unit 26 being emitted upwards at an angle of reflected beam of 45° to the horizontal plane of arrangement of the first light-emitting unit 26. As a result, a parabolic line of light can be imaged on the surface of the spinning can 4, whereby the lowest point of the parabola is congruent with the centre of the spinning can along a horizontal axis of the spinning can 4, in particular in the case of a spinning can 4 embodied as a round can, whereby the spinning can centre can be detected exactly in order to be able to undertake positioning in front of the spinning can 4 in an improved manner. The line of light of the second light transmitter 27 is imaged approximately as a horizontal line on the surface of the spinning can 4 and enables the detection of the fibre band end hanging down on the outside from a spinning can rim. The arrangement height of the second light transmitter 27 on the take-up unit 8 can be selected in such a way that it corresponds to a height of the spinning can rim area from the floor, into which a fibre band end usually reaches when hanging down from the spinning can rim.

The respective lines of light are detected by the receiver unit 28 as soon as they hit the surface of the spinning can 4, for example, and are reflected by it. The receiver unit 28 may be a camera. The detected signals of the corresponding lines of light are provided to a control unit of the manipulator unit, which evaluates from the detected signals a position of the spinning can 4 as well as the presence or absence of a fibre band end hanging down from the spinning can rim in the irradiated and monitored area, in order to control the manipulator unit 23c for defined handling of the spinning can 4.

An operating unit 24 is arranged on the take-up unit 8, via which the manipulator unit 23c and the transport vehicle 1c can be operated and/or adjusted by an operator.

FIG. 7 shows a schematic illustration of a top view of a fourth embodiment of a driverless transport vehicle 1d. In contrast to the previously described transport vehicles 1a-1c, the transport vehicle 1d has two coaxially arranged, rotatable transport platforms 6d for carrying three spinning cans 4 each, the manipulator unit 23d being arranged in a spandrel of the two rotatable transport platforms 6d.

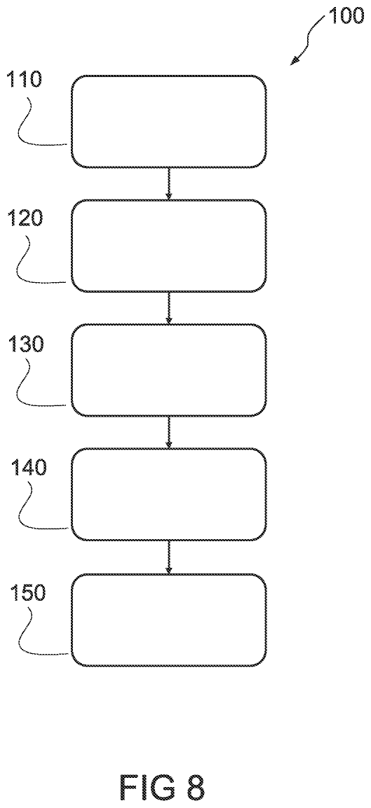

FIG. 8 shows a schematic illustration of a spinning can replacement process 100. First, a driverless transport vehicle 1a, 1b, 1c, 1d loaded with at least one spinning can 4 filled with fibre band is moved to a spinning machine according to one of the preceding embodiments (step 110). In a subsequent step 120, the driverless transport vehicle 1a, 1b, 1c, 1d is positioned at the spinning machine in front of the spinning can 4 to be replaced. The exact positioning of the transport vehicle 1a, 1b, 1c, 1d can be carried out by a detection unit 25 as described above, comprising at least the first light transmitter 26 and the receiver unit 28. In a subsequent step 130, the spinning can 4 to be replaced is moved by the driverless transport vehicle 1a, 1b, 1c, 1d from an operating position to a receiving position spaced from the operating position, either positioned there until the operating position is occupied by a filled spinning can 4 or alternatively placed subsequently on a free space on the transport platform 6, 6c, 6d by the manipulator unit 23a, 23b, 23c, 23d following the transfer to the receiving position. The transfer can be carried out in particular by a pusher body 14 as described above, which is subjected to negative pressure after contacting the spinning can surface in order to fix the spinning can 4 in place at the pusher body 14. The spinning can 4 can be brought exactly into the take-up position by moving the pusher body 14 via the actuating device 5c and the gripper 3. In a step 140, the spinning can 4 filled with fibre band is taken up from the transport platform 6, 6c, 6d by the manipulator unit 23a, 23b, 23c, 23d and set down next to the driverless transport vehicle 1a, 1b, 1c, 1d. In a further step 150, the filled spinning can 4 that has been set down is brought into the free operating position by the driverless transport vehicle 1a, 1b, 1c, 1d. The spinning can 4 can be brought into operating position in a manner equivalent to bringing it into the take-up position by the pusher body 14.

“Can” and “May” refer in particular to optional features of the invention. Accordingly, there are also further developments and/or examples of embodiments of the present invention which additionally or alternatively have the respective feature or features.

If necessary, isolated features can also be picked out from the feature combinations disclosed herein and used in combination with other features to delimit the subject-matter of the claim, while eliminating any structural and/or functional connection that may exist between the features.

### LIST OF REFERENCE SIGNS

1a, 1b, 1c, 1d Transport vehicle
2 Travelling drive
3 Gripper
4 Spinning can
5b, 5c Actuating device
6, 6c, 6d Transport platform
7 Gripper arm
8 Take-up unit
9 Cantilever
10 First gripper arm body
11 Second gripper arm body
12 Gripper elements
13a, 13b, 13c Pushing apparatus
14 Pusher body
15 Metal ring
16 Jacket surface
17 Fibre band end
18 Support strut
19 Gripper arm support
20 Gripper base body
21 Gripper retainer
22a, 22b, 22c Pusher body support
23a, 23b, 23c, 23d Manipulator unit
24 Operating unit
25 Detection unit
26 First light-emitting unit
27 Second light-emitting unit
28 Receiver unit
29 Contact area
30 Platform
31 Central axis
32 Parking position

1. A driverless transport vehicle for autonomous transport and replacement of at least one spinning can comprising:
an autonomous travelling drive;
a transport platform for taking up the at least one spinning can; and
an autonomous manipulator unit for taking up and setting down the at least one spinning can, whereby the autonomous manipulator unit includes a gripper for gripping the at least one spinning can and an actuating device for adjusting the gripper.

2. The driverless transport vehicle according to claim 1, further including a take-up unit which is arranged on the transport platform and mounts the autonomous manipulator unit and an operating unit communicatively connected to the autonomous manipulator unit in a raised manner with respect to a surface of the transport platform for operation by an operator of at least the autonomous manipulator unit.

3. The driverless transport vehicle according to claim 1, wherein a control unit of the autonomous manipulator unit is arranged in, on or on the take-up unit.

4. The driverless transport vehicle according to claim 1, wherein the autonomous manipulator unit comprises a collaborating robot, wherein the actuating device comprises a robot arm and the gripper comprises a robot hand of the collaborating robot.

5. The driverless transport vehicle according to claim 1, wherein the gripper comprises two gripper elements, wherein a first one of the two gripper elements is arranged in a stationary manner and a second one of the two gripper elements is arranged in a linearly adjustable manner on a support strut of the gripper in a direction of the first one of the two gripper elements and away from the latter, in order to assume a release position releasing the at least one spinning can and a holding position locking the at least one spinning can in a course of adjustment.

6. The driverless transport vehicle according to claim 5, wherein each of the two gripper elements has in each case at least two contact surfaces for contacting the at least one spinning can, the contact surfaces of each of the two gripper elements being arranged at a distance from one another on each of the two gripper elements, at least one of the contact surfaces per each of the two gripper elements having a static-friction structure for contacting the at least one spinning can.

7. The driverless transport vehicle according to claim 5, further including a signal transmitter that is arranged on one of the two gripper elements and embodied to signal contacting of the two gripper elements.

8. The driverless transport vehicle according to no of the claim 5, further including a pushing apparatus arranged on the gripper and having a pusher body which can be brought into engagement with the at least one spinning can for bottom-level displacement of the at least one spinning can.

9. The driverless transport vehicle according to claim 8, wherein the pusher body has a coupling unit for releasable tension-resistant connection to the at least one spinning can, the coupling unit having a vacuum unit which is arranged on the first one of the two gripper elements on a side facing away from the second one of the two gripper elements.

10. The driverless transport vehicle according to claim 2, wherein the take-up unit comprises a detection unit for detecting a position of the at least one spinning can and/or of a fibre band end arranged in the at least one spinning can.

11. The driverless transport vehicle according to claim 10, wherein the detection unit is embodied for camera-based, laser-based and/or sensor-based detection of a position of the at least one spinning can and/or of the fibre band end in the at least one spinning can.

12. A process for replacing at least one spinning can on a spinning machine comprising:
moving the driverless transport vehicle according to claim 1 loaded with at least one spinning can filled with fibre band to the spinning machine;
positioning the driverless transport vehicle on the spinning machine in front of the at least one spinning can to be replaced;
moving the at least one spinning can to be replaced by the driverless transport vehicle, from an operating position to a take-up position at a distance from the operating position;
picking up the at least one spinning can filled with fibre band from the transport platform by the autonomous manipulator unit and the setting of the at least one spinning can down next to the driverless transport vehicle; and
moving the filled spinning can that has been set down into a free operating position by the driverless transport vehicle.
